(19) United States
(12) Patent Application Publication
(10) Pub. No.: US 2026/0075462 A1
(43) Pub. Date: Mar. 12, 2026

(54) PACKET LOSS HANDLING METHOD AND APPARATUS

(71) Applicant: BEIJING XIAOMI MOBILE SOFTWARE CO., LTD., Beijing (CN)

(72) Inventors: Yanhua LI, Beijing (CN); Jinhua WU, Beijing (CN)

(73) Assignee: BEIJING XIAOMI MOBILE SOFTWARE CO., LTD., Beijing (CN)

(21) Appl. No.: 19/115,247

(22) PCT Filed: Sep. 29, 2022
(86) PCT No.: PCT/CN2022/122943

§ 371 Date: Mar. 25, 2025

(51) Int. Cl. H04W 28/06; H04L 67/131

(52) U.S. Cl. CPC H04W 28/06; H04L 67/131

(57) ABSTRACT

A packet loss handling method, includes: sending, by a first node, first information to a second node, wherein the first information includes a packet to be discarded or packet loss-related information.

### CROSS-REFERENCE TO RELATED APPLICATION

The present application is the U.S. national phase of International Application No. PCT/CN2022/122943, filed on Sep. 29, 2022, the content of which is incorporated herein by reference in its entirety for all purposes.

### TECHNICAL FIELD

The disclosure relates to the field of communication technology, in particular to a packet loss handling method and a packet loss handling apparatus.

### BACKGROUND

In the related art, multipath transmission and the concept of multipath modeling have been introduced in Extended Reality (XR) services, through which, data may be classified according to its importance, such as I frame and P frame modeling. The I frame may be understood as a relatively important frame, which may be used by a terminal for decoding, while the P frame cannot be used alone for decoding. Therefore, on the core network side, a possible processing mechanism is that when the I frame is not transmitted and received correctly, data packets corresponding to the P frame associated with the I frame may be discarded to avoid unnecessary transmission and a waste of wireless interface resources.

If a certain number of data packets corresponding to other frames associated with important frame are discarded because the wireless side cannot send the important frame correctly, it may cause inconsistency between the traffic statistics on the core network side and the traffic statistics on the terminal side.

### SUMMARY

According to a first aspect of embodiments of the disclosure, a packet loss handling method is provided. The method is performed by a first node, and includes:
sending first information to a second node, in which the first information comprises a packet to be discarded or packet loss-related information.

According to a second aspect of embodiments of the disclosure, a packet loss handling method is provided. The method is performed by a second node, and includes:
receiving first information sent by a first node, in which the first information includes a packet to be discarded or packet loss-related information.

According to a third aspect of embodiments of the disclosure, a communication apparatus is provided. The communication apparatus includes a processor and a memory, in which the memory stores a computer program which, when executed by the processor, causes the apparatus to implement the method of the first aspect or the method of the second aspect.

### BRIEF DESCRIPTION OF THE DRAWINGS

In order to clearly illustrate technical solutions of embodiments of the disclosure or background technologies, a description of drawings used in the embodiments of the disclosure or the background technologies is given below.

FIG. 1 is a schematic diagram of a communication system according to an embodiment of the disclosure.

FIG. 2 is a flowchart of a packet loss handling method according to an embodiment of the disclosure.

FIG. 3 is a flowchart of a packet loss handling method according to another embodiment of the disclosure.

FIG. 4 is a flowchart of a packet loss handling method according to another embodiment of the disclosure.

FIG. 5 is a flowchart of a packet loss handling method according to another embodiment of the disclosure.

FIG. 6 is a flowchart of a packet loss handling method according to another embodiment of the disclosure.

FIG. 7 is a flowchart of a packet loss handling method according to another embodiment of the disclosure.

FIG. 8 is a flowchart of a packet loss handling method according to another embodiment of the disclosure.

FIG. 9 is a flowchart of a packet loss handling method according to another embodiment of the disclosure.

FIG. 10 is a flowchart of a packet loss handling method according to another embodiment of the disclosure.

FIG. 11 is a flowchart of a packet loss handling method according to another embodiment of the disclosure.

FIG. 12 is a flowchart of a packet loss handling method according to another embodiment of the disclosure.

FIG. 13 is a schematic diagram of a packet loss handling apparatus according to another embodiment of the disclosure.

FIG. 14 is a schematic diagram of a packet loss handling apparatus according to another embodiment of the disclosure.

FIG. 15 is a schematic diagram of a communication apparatus according to an embodiment of the disclosure.

FIG. 16 is a schematic diagram of a chip according to an embodiment of the disclosure.

### DETAILED DESCRIPTION

In order to better understand a packet loss handling method and a packet loss handling apparatus disclosed in the embodiments of the disclosure, a communication system to which the embodiments of the disclosure are applied will be described first.

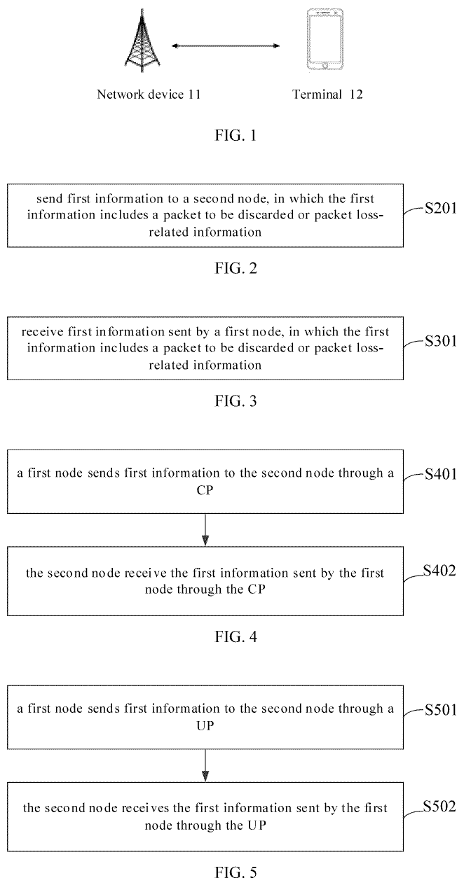

Referring to FIG. 1, FIG. 1 is a structural diagram of a communication system provided by an embodiment of the disclosure. The communication system may include, but is not limited to, one network device and one terminal. The number and the form of devices illustrated in FIG. 1 are only for examples and do not constitute a limitation on the embodiments of the disclosure, and two or more network devices and two or more terminals may be included in practical applications. The communication system illustrated in FIG. 1 includes, for example, a network device 11 and a terminal 12.

It is noteworthy that the technical solutions of the embodiments of the disclosure may be applied to various communication systems, such as, a long term evolution (LTE) system, a 5th generation (5G) mobile communication system, a 5G new radio (NR) system, or other future new mobile communication systems.

The network device 11 in the embodiment of the disclosure is an entity on a network side for transmitting or receiving signals. For example, the network device 11 may be an evolved NodeB (eNB), a transmission reception point (TRP), a next generation NodeB (gNB) in a NR system, a base station in other future mobile communication systems, or an access node in a wireless fidelity (WiFi) system. The specific technology and specific device form adopted by the network device are not limited in the embodiment of the disclosure. The network device according to the embodiment of the disclosure may be composed of a central unit (CU) and a distributed unit (DU). The CU may also be called control unit. The use of CU-DU structure allows to divide a protocol layer of the network device, such as a base station, such that some of functions of the protocol layer are placed in the CU for a centralized control, and some or all of the remaining functions of the protocol layer are distributed in the DU, and the DU is centrally controlled by the CU.

The terminal 12 in the embodiment of the disclosure is an entity on a user side for receiving or transmitting signals, such as a cellular phone. The terminal may also be referred to as terminal, user equipment (UE), mobile station (MS), mobile terminal (MT), and the like. The terminal may be a car with communication functions, a smart car, a mobile phone, a wearable device, a Pad, a computer with wireless transceiver functions, a virtual reality (VR) terminal, an augmented reality (AR) terminal, a wireless terminal in industrial control, a wireless terminal in self-driving, a wireless terminal in remote medical surgery, a wireless terminal in smart grid, a wireless terminal in transportation safety, a wireless terminal in smart city, a wireless terminal in smart home, etc. The specific technology and specific device form adopted by the terminal are not limited in the embodiment of the disclosure.

It is understandable that the communication system described in the embodiment of the disclosure is intended to clearly illustrate the technical solutions according to the embodiments of the disclosure, and does not constitute a limitation on the technical solutions according to the embodiments of the disclosure. It is understandable by those skilled in the art that as system architectures evolve and new business scenarios emerge, the technical solutions according to the embodiments of the disclosure are also applicable to similar technical problems.

In the related art, multipath transmission and the concept of multipath modeling have been introduced in Extended Reality (XR) services, through which, data may be classified according to its importance, such as I frame and P frame modeling. The I frame may be understood as a relatively important frame, which may be used by a terminal for decoding, while the P frame cannot be used alone for decoding. Therefore, on a wireless side, a possible processing mechanism is that when the I frame is not transmitted and received correctly, data packets corresponding to the P frame associated with the I frame may be discarded to avoid unnecessary transmission and a waste of wireless interface resources.

When a certain number of data packets corresponding to other frames associated with important frames are discarded because the wireless side cannot send the important frame correctly, it may cause an inconsistency between the traffic statistics on the core network side and the traffic statistics on the terminal side.

FIG. 2 is a flowchart of a packet loss handling method provided by an embodiment of the disclosure. The method is performed by a first node. As illustrated in FIG. 2, the method includes, but is not limited to, the following step.

At step S201, first information is sent to a second node, in which the first information includes a packet to be discarded or packet loss-related information.

The first node sends the packet to be discarded or the packet loss-related information to the second node to assist the second node in performing traffic statistics, to avoid an inconsistency with the traffic statistics on a terminal side.

As an embodiment, the packet to be discarded refers to a data packet to be discarded, and the packet loss-related information is generated according to packet loss statistics, which is performed based on a physical packet to be discarded in the first node.

As an embodiment, the packet loss statistics are performed based on a packet data convergence protocol (PDCP) in the first node. When the PDCP layer performs the packet loss statistics, it may also refer to a result of packet loss statistics for a radio link control (RLC) entity in the node for the statistics. For example, when the PDCP layer counts that a packet loss amount is X (possibly based on an expiration of a losing timer), and packet loss amount of the RLC layer is Y, the packet loss amount of the final PDCP statistics needs to consider a sum of the packet loss amount of the PDCP layer itself and the packet loss amount of the RLC layer.

As an embodiment, the statistics is performed based on packet loss signaling sent by the first node to other nodes. For example, the PDCP may count the packet loss-related information based on the packet loss signaling sent to the RLC.

As an embodiment, it may be the packet loss-related information received by the first node from other nodes. For example, a PDCP of a centralized unit (CU) may count the packet loss-related information based on packet loss signaling from an RLC of a DU. The implementation of the packet loss statistics is not limited in the embodiment of the disclosure.

An embodiment of the disclosure also provides another packet loss handling method. FIG. 3 is a flowchart of a packet loss handling method provided by another embodiment of the disclosure. The method may be applied to a second node. The packet loss handling method may be executed alone, in combination with any embodiment of the disclosure or any possible implementation in the embodiment, or in combination with any technical scheme in the related art.

As illustrated in FIG. 3, the method includes the following step.

At step S301, first information sent by a first node is received, in which the first information includes a packet to be discarded or packet loss-related information.

The first node sends the packet to be discarded or the packet loss-related information to the second node, and the second node receives the first information sent by the first node for traffic statistics, to avoid an inconsistency with the traffic statistics on a terminal side.

In some embodiments, when the second node is a node responsible for statistics (for example, a session management function (SMF) or a user plane function (UPF)), the second node performs statistics according to the packet to be discarded or the packet loss-related information.

In some embodiments, the packet to be discarded or a data packet in packet loss statistics is caused by a fact that an important data packet associated with it cannot be sent correctly.

In the embodiment of the disclosure, the packet to be discarded may also refer to a data packet to be returned.

In some embodiments, when the second node is not the node responsible for statistics (for example, a node on a base station), the second node forwards the packet to be discarded or the packet loss-related information to the node responsible for statistics or a node having a signaling connection with it, so that the node responsible for statistics or the node having a signaling connection with it performs statistics according to the packet to be discarded or the packet loss-related information.

In some embodiments, the first node sends the packet to be discarded or the packet loss-related information to the second node, and the packet to be discarded or the packet loss-related information received by the second node is used to assist a core network in performing cost statistics, to assist a core network in performing traffic statistics and the cost statistics, which may avoid an inconsistency with cost statistics on the terminal side.

An embodiment of the disclosure also provides another packet loss handling method. FIG. 4 is a flowchart of a packet loss handling method provided by another embodiment of the disclosure. The method may be performed by a second node. The packet loss handling method may be executed alone, in combination with any embodiment of the disclosure or any possible implementation in the embodiment, or in combination with any technical scheme in the related art.

As illustrated in FIG. 4, the packet loss handling method includes the following steps.

At step S401, a first node sends first information to the second node through a control plane (CP).

The first information includes a packet to be discarded or packet loss-related information. The packet loss-related information includes at least one of: a bearer identifier (ID) corresponding to packet loss, a packet loss time, a packet loss data volume, a packet loss rate, a packet loss cause or a reporting cause. The bearer ID corresponding to the packet loss includes, but is not limited to, a data radio bearer (DRB) ID, a quality of service (QOS) flow identifier (QFI), a protocol data unit (PDU) session ID, and a PDU set ID. The packet loss time includes, but is not limited to, a start timestamp and an end timestamp. The packet loss data volume includes, but is not limited to, a data volume, and the packet loss data volume may be divided into uplink data volume and/or downlink data volume. The packet loss rate is a proportion of the packet to be discarded. The packet loss cause includes, but is not limited to, a loss of an important frame. The reporting cause includes, but is not limited to, periodic reporting, handover reporting, and connection release. The packet loss-related information is not limited in the embodiment of the disclosure.

In a separated architecture of a wireless network, a base station-centralized unit-control plane (gNB-CU-CP) is responsible for functions of radio resource control (RRC) and PDCP CP.

Sending the first information to the second node through the CP includes, but is not limited to, sending the first information to the second node through a signaling of the CP.

The first node is a base station-distributed unit (gNB-DU), the second node is a base station-centralized unit (gNB-CU) or the gNB-CU-CP, and the first information is a F1 application protocol (F1AP) message. The F1AP message may be packet loss statistics reporting message and/or other F1AP messages.

In some embodiments, the first node is a base station-centralized unit-user plane (gNB-CU-UP), the second node is the gNB-CU-CP, and the first information is an E1 application protocol (E1AP) message. The E1AP message may be packet loss statistics reporting message and/or other E1AP messages.

In some embodiments, the first node is a secondary node in a dual connectivity (DC) scenario, the second node is a master node in the DC scenario, and the first information is an Xn application protocol (XnAP) message. The XnAP message may be packet loss statistics reporting message and/or other XnAP messages.

In some embodiments, the first node is a gNB, a gNB-CU, a gNB-CU-CP or a gNB-CU-UP, the second node is a core network node (for example, a SMF), and the first information is an NG application protocol (NGAP) message. The NGAP message may be packet loss statistics reporting message and/or other NGAP messages.

It should be understood that the above is only an example, and the first node, the second node and the first information are not limited to this.

Specific implementation of the packet loss statistics performed by the first node may be referred to the above embodiments, and details are not repeated here.

At step S402, the second node receive the first information sent by the first node through the CP.

Corresponding to the first node, when the second node receives the first information, the second node receives the first information also based on the CP. The explanation about the CP may be referred to the detailed description of step S301, which is not repeated here.

In conclusion, the first node sends the packet to be discarded or the packet loss-related information to the second node through the CP, and the second node receives the packet to be discarded or the packet loss-related information, in which the packet to be discarded or the packet loss-related information may be used to assist a core network in performing traffic statistics and/or cost statistics, so as to avoid an inconsistency with the traffic and/or cost statistics on a terminal side.

An embodiment of the disclosure provides another packet loss handling method. FIG. 5 is a flowchart of a packet loss handling method provided by another embodiment of the disclosure. The method may be performed by a second node. The packet loss handling method may be executed alone, in combination with any embodiment of the disclosure or any possible implementation in the embodiment, or in combination with any technical scheme in the related art.

As illustrated in FIG. 5, the packet loss handling method includes the following steps.

At step S501, a first node sends first information to the second node through a UP.

The first information includes a packet to be discarded or packet loss-related information. The description of the packet loss-related information may be referred to the above embodiments, which will not be repeated here.

In a separated architecture of a wireless network, a gNB-CU-UP is responsible for functions of a general packet radio service (GPRS) tunneling protocol for the UP (GTP-U), a service data adaptation protocol (SDAP) and a PDCP UP.

Sending the first information to the second node through the UP includes, but is not limited to, sending the first information to the second node through user data of the UP.

In some embodiments, the first node is a gNB-DU, and the second node is a gNB-CU or a gNB-CU-UP.

In some embodiments, the first node is a gNB, a gNB-CU or a gNB-CU-UP, and the second node is a UPF.

In some embodiments, the first node is a secondary node in a DC scenario, and the second node is a master node in the DC scenario.

It should be understood that the above is only an example, and the first node and the second node are determined based on at least one of the above, and the first node and the second node are not limited in the embodiment of the disclosure.

At step S502, the second node receives the first information sent by the first node through the UP.

Corresponding to the first node, when the second node receives the first information, the second node receives the first information also based on the UP. The explanation about the UP may be referred to the detailed description of step S401, which is not repeated here.

In conclusion, the first node sends the packet to be discarded or the packet loss-related information to the second node through the UP, and the second node receives the packet to be discarded or the packet loss-related information, in which the packet to be discarded or the packet loss-related information may be used to assist a core network in performing traffic and/or cost statistics, so as to avoid an inconsistency with the traffic and/or cost statistics on a terminal side.

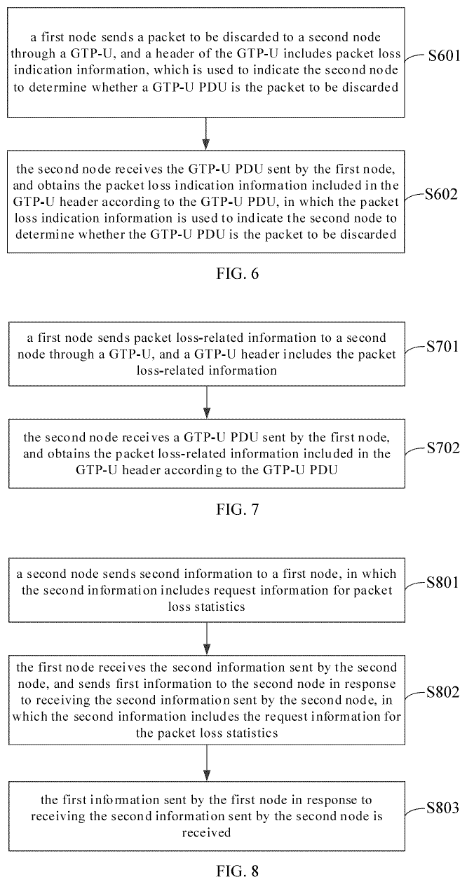

An embodiment of the disclosure also provides another packet loss handling method. FIG. 6 is a flowchart of a packet loss handling method provided by another embodiment of the disclosure. The packet loss handling method may be executed alone, in combination with any embodiment of the disclosure or any possible implementation in the embodiment, or in combination with any technical scheme in the related art.

As illustrated in FIG. 6, the packet loss handling method includes the following steps.

At step S601, a first node sends a packet to be discarded to a second node through a GTP-U, and a GTP-U header includes packet loss indication information, in which the packet loss indication information is used to indicate the second node to determine whether a GTP-U PDU is the packet to be discarded.

In some embodiments, the first node sends the packet to be discarded to the second node, in which the packet to be discarded refers to a packet received by the first node from the second node. The first node does not send the data packet to a terminal (for example, other packets related to the parsing of the packet are not sent correctly), but discards the packet, so that the second node may calculate a data volume corresponding to the packet loss according to the packet to be discarded for traffic and/or cost statistics.

In some examples, the first node sends the packet to be discarded to the second node through the GTP-U, and the packet loss indication information is included in the GTP-U header corresponding to the packet to be discarded. The packet loss indication information is used for the second node to determine whether the GTP-U PDU is the packet to be discarded.

In some embodiments, the packet to be discarded or a data packet in packet loss statistics is caused by a fact that an important data packet associated with it cannot be sent correctly.

In the disclosure, the packet to be discarded may also refer to a data packet to be returned.

The specific implementation of the packet loss statistics performed by the first node may be referred to the above embodiments, and details are not repeated here.

At step S602, the second node receives the GTP-U PDU sent by the first node, and obtains the packet loss indication information included in the GTP-U header according to the GTP-U PDU, in which the packet loss indication information is used to indicate the second node to determine whether the GTP-U PDU is the packet to be discarded.

In the embodiment of the disclosure, the packet loss indication information may also refer to packet return indication information, and “packet loss” and “packet return” have the same meaning.

Corresponding to the first node, the second node receives the GTP-U PDU sent by the first node, parses the GTP-U PDU to obtain the packet loss indication information included in the GTP-U header, and determines whether the data packet received this time is the packet to be discarded according to the packet loss indication information. When the second node determines that the data packet is the packet to be discarded, the data packet is discarded. When the second node determines that the data packet is not the packet to be discarded, the traffic and/or cost statistics may be performed based on the received data packet.

In conclusion, the first node sends the packet to be discarded to the second node through the GTP-U, and the GTP-U header includes the packet loss indication information. The second node receives the GTP-U PDU sent by the first node, obtains the packet loss indication information included in the GTP-U header according to the GTP-U PDU, and assists a core network in performing the traffic and/or cost statistics according to the packet loss indication information, so as to avoid an inconsistency with the traffic and/or cost statistics on a terminal side.

An embodiment of the disclosure also provides another packet loss handling method. FIG. 7 is a flowchart of a packet loss handling method provided by another embodiment of the disclosure. The packet loss handling method may be executed alone, in combination with any embodiment of the disclosure or any possible implementation in the embodiment, or in combination with any technical scheme in the related art.

As illustrated in FIG. 7, the packet loss handling method includes the following steps.

At step S701, a first node sends packet loss-related information to a second node through a GTP-U, and a GTP-U header includes the packet loss-related information.

In some embodiments, the first node sends the packet loss-related information to the second node, and the statistical packet to be discarded in the packet loss-related information refers to a data packet received by the first node from the second node. The first node does not send the data packet to a terminal (for example, other data packets related to the parsing of the data packet are not sent correctly), but discards or returns the data packet. The second node may calculate a data volume corresponding to the packet loss or the packet return according to the packet loss-related information for accurate traffic and/or cost statistics.

In some embodiments, the first node sends the packet loss-related information to the second node, and the packet loss-related information is included in the GTP-U header.

In some embodiments, the packet loss-related information includes at least one of: a bearer ID corresponding to packet loss, a packet loss time, a packet loss data volume, a packet loss rate, a packet loss cause and a reporting cause. Examples and explanations for the bearer ID corresponding to packet loss, the packet loss time, the packet loss data volume, the packet loss rate, the packet loss cause and the reporting cause may be referred to the above embodiments, which will not be repeated here.

In some embodiments, the packet loss-related information is generated according packet loss statistics, which is performed based on a physical packet to be discarded in the first node. The specific implementation of the first node performing the packet loss statistics may be referred to the above embodiments, and details will not be repeated here.

At step S702, the second node receives a GTP-U PDU sent by the first node, and obtains the packet loss-related information included in the GTP-U header according to the GTP-U PDU.

Corresponding to the first node, the second node receives the GTP-U PDU sent by the first node, parses the GTP-U PDU to obtain the packet loss-related information included in the GTP-U header, determines whether the data packet received this time is the packet to be discarded or a returned data packet according to the packet loss-related information, and performs the traffic and/or cost statistics based on the received data packet.

In some embodiments, when the second node determines that the data packet received this time is the packet to be discarded or the returned data packet, the second node will subtract the packet to be discarded or the returned data packet from the traffic and/or charging statistics.

In conclusion, the first node sends the packet loss-related information to the second node through the GTP-U PDU. The second node receives the GTP-U PDU sent by the first node, obtains the packet loss-related information included in the GTP-U header according to the GTP-U PDU, and assists a core network in performing the traffic and/or cost statistics according to the packet loss-related information, so as to avoid an inconsistency with the traffic and/or cost statistics on a terminal side.

An embodiment of the disclosure also provides another packet loss handling method. FIG. 8 is a flowchart of a packet loss handling method provided by another embodiment of the disclosure. The packet loss handling method may be executed alone, in combination with any embodiment of the disclosure or any possible implementation in the embodiment, or in combination with any technical scheme in the related art.

As illustrated in FIG. 8, the packet loss handling method includes the following steps.

At step S801, a second node sends second information to a first node, in which the second information includes request information for packet loss statistics.

The second information is used to indicate the first node to send the packet loss statistics. That is, the second node, as a requester for the packet loss statistics, requests the first node whether to send the packet loss statistics or when to send the packet loss statistics or other control, and the first node performs the packet loss statistics, processing and/or reporting according to the request of the second node. In detail, the specific contents in the second information is not limited in the disclosure.

At step S802, the first node receives the second information sent by the second node, and sends first information to the second node in response to receiving the second information sent by the second node, in which the second information includes the request information for the packet loss statistics.

In some implementations, the first node sends a packet to be discarded or packet loss-related information to the second node. In addition to the case in which the second information is received in this step, as a possible implementation of this embodiment, the first node may also send the packet to be discarded or the packet loss-related information to the second node according to a preset protocol agreement. As another possible implementation of this embodiment, the first node may send the packet to be discarded or the packet loss-related information to the second node according to an operation administration and maintenance (OAM) configuration. Specifically, the embodiment of the disclosure does not make specific restrictions on this.

In the embodiment of this disclosure, “in response to” has the same meaning as “according to”or “considering”.

At step S803, the first information sent by the first node in response to receiving the second information sent by the second node is received.

The first information includes the packet to be discarded or the packet loss-related information. The description of the first information may be referred to the above embodiments and will not be repeated here.

Corresponding to the first node, the second node receives the first information sent by the first node, parses the first information to obtain the packet to be discarded or the packet loss-related information included in the first information, and performs traffic and/or cost statistics according to the packet to be discarded or the packet loss-related information.

In conclusion, in response to receiving the second information sent by the second node, in which the second information includes the request information for the packet loss statistics, the first node sends the first information related to the packet loss statistics to the second node. The second node obtains the packet to be discarded or the packet loss-related information included in the first information to assist a core network in performing the traffic and/or cost statistics, so as to avoid an inconsistency with the traffic and/or cost statistics on a terminal side.

An embodiment of the disclosure also provides another packet loss handling method. FIG. 9 is a flowchart of a packet loss handling method provided by another embodiment of the disclosure. The packet loss handling method may be executed alone, in combination with any embodiment of the disclosure or any possible implementation in the embodiment, or in combination with any technical scheme in the related art.

As illustrated in FIG. 9, the packet loss handling method includes the following steps.

At step S901, a second node sends second information to a first node through a UP.

The second information is used to indicate the first node to send packet loss statistics. That is, the second node, as a controller of the packet loss statistics, indicates the first node whether to send the packet loss statistics or when to send the packet loss statistics or other control. In detail, the specific contents contained in the second information is not limited in the disclosure.

Sending the second information to the first node through the UP, includes specifically, but is not limited to, sending the second information to the first node through user data of the UP.

In a separated architecture of wireless network, a gNB-CU-UP is responsible for functions of a GTP-U, an SDAP and a PDCP UP.

In some embodiments, the first node is a gNB-DU, and the second node is a gNB-CU or the gNB-CU-UP.

In some embodiments, the first node is a gNB, a gNB-CU or the gNB-CU-UP, and the second node is a UPF.

In some embodiments, the first node is a secondary node, and the second node is a master node.

It should be understood that the above is only an example, and the first node and the second node are determined based on at least one of the above, and the first node and the second node are not limited in the embodiment of the disclosure.

At step S902, the first node receives the second information sent by the second node through the UP.

Corresponding to the second node, when receiving the second information, the first node receives the second information also based on the UP. The explanation about the UP may be referred to the detailed description of step S801, which will not be repeated here.

In conclusion, in response to receiving the second information sent by the second node through the UP, in which the second information includes the request information for the packet loss statistics, the first node sends the first information related to the packet loss statistics to the second node. The second node obtains the packet to be discarded or the packet loss related information included in the first information to assist a core network in performing traffic and/or cost statistics, so as to avoid an inconsistency with the traffic and/or cost statistics on a terminal side.

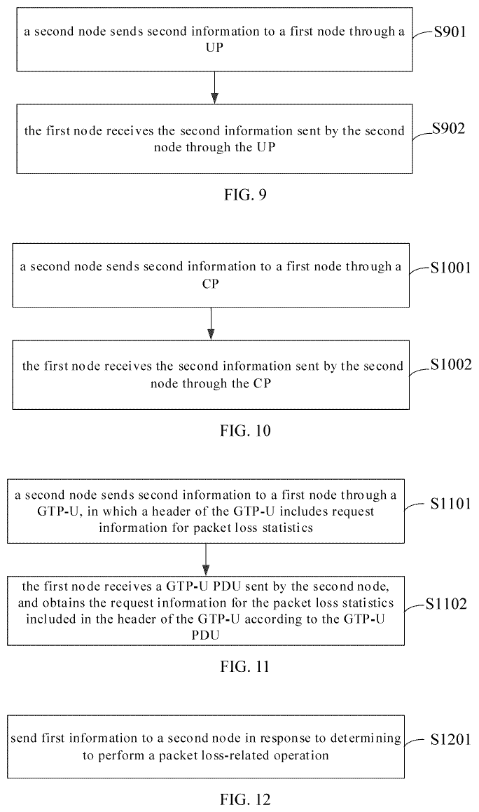

An embodiment of the disclosure also provides another packet loss handling method. FIG. 10 is a flowchart of a packet loss handling method provided by another embodiment of the disclosure. The packet loss handling method may be executed alone, in combination with any embodiment of the disclosure or any possible implementation in the embodiment, or in combination with any technical scheme in the related art.

As illustrated in FIG. 10, the packet loss handling method includes the following steps.

At step S1001, a second node sends second information to a first node through a CP.

The second information is used to indicate the first node to send packet loss statistics. That is, the second node, as a requester of packet loss statistics, requests the first node whether to send the packet loss statistics or when to send the packet loss statistics or other control, and the first node performs the packet loss statistics, processing and/or reporting according to the request of the second node. In detail, the specific contents contained in the second information is not limited in the disclosure.

Sending the second information to the first node through the CP, includes, but is not limited to: sending the second information to the first node through a signaling of the CP.

In some embodiments, the first node is a gNB-DU, the second node is a gNB-CU or a gNB-CU-CP, and the second message is an F1AP message. The F1AP message may be a UE context request message, a UE context modification request message or other F1AP messages.

In some embodiments, the first node is a gNB-CU-UP, the second node is a gNB-CU-CP, and the second message is an E1AP message. The E1AP message may be a bearer context request message, a bearer context modification request message or other E1AP messages.

In some embodiments, the first node is a master node, the second node is a secondary node, and the second message is an XnAP message. The XnAP message is an SN addition request message, an SN modification request message or other XnAP messages.

In some embodiments, the first node is a target gNB, the second node is a source gNB, and the second message is an XnAP message. The XnAP message is a handover request message, a UE context retrieval feedback message or other XnAP messages.

In some embodiments, the first node is a gNB, a gNB-CU, a gNB-CU-CP or a gNB-CU-UP, the second node is a core network node, and the second message is an NGAP message. The NGAP message may be a UE context setup request message, a UE context modification request message, a PDU session resource setup request message, a PDU session resource modification request message or other NGAP messages.

The above examples are exemplary, and the specific contents of the first node, the second node and the second information are not limited in the embodiment of the disclosure.

At step S1002, the first node receives the second information sent by the second node through the CP.

Corresponding to the second node, when receiving the second information sent by the second node through the CP, the first node receives the second information also based on the CP. The explanation about the CP may be referred to the detailed description of step S901, which will not be repeated here.

In conclusion, in response to receiving the second information sent by the second node through the CP, in which the second information includes the request information for the packet loss statistics, the first node sends the first information related to the packet loss statistics to the second node. The second node obtains a packet to be discarded or packet loss-related information included in the first information to assist a core network in performing traffic and/or cost statistics, so as to avoid an inconsistency with the traffic and/or cost statistics on a terminal side.

An embodiment of the disclosure also provides another packet loss handling method. FIG. 11 is a flowchart of a packet loss handling method provided by another embodiment of the disclosure. The packet loss handling method may be executed alone, in combination with any embodiment of the disclosure or any possible implementation in the embodiment, or in combination with any technical scheme in the related art.

As illustrated in FIG. 11, the packet loss handling method includes the following steps.

At step S1101, a second node sends second information to a first node through a GTP-U, in which a header of the GTP-U includes request information for packet loss statistics.

This embodiment is used in a process of sending the second information to the first node through a UP.

In some embodiments, the second node sends the request information for packet loss statistics to the first node through the GTP-U. In some embodiments, the request information for packet loss statistics includes at least one of:
a packet loss statistical indication, for example, a packet loss report query (e.g., Discard Report polling) may be carried in the header of the GTP-U to indicate that a packet loss-related operation is needed to be performed;
a bearer ID of packet loss reporting, e.g., a DRB, a QFI, a PDU session ID or a PDU set ID, which is used to indicate a granularity of the packet loss-related operation of the first node;
a threshold of packet loss reporting, in which the threshold may be a packet size or a packet loss rate, and in respond to the threshold being satisfied, the first node performs the reporting;
a time of packet loss reporting, in which the time may be a specific time period and/or a reporting cycle, which is used to indicate when the first node performs the reporting related to the packet loss; or
a mode of packet loss reporting, including a UP reporting, a CP reporting, returning a packet to be discarded and/or a packet loss size indication, etc., in which the reporting mode is configured to indicate how the first node performs the reporting relate to the packet loss.

The above is an example of the request information of the packet loss statistics, and the request information of the packet loss statistics is not limited in this embodiment of the disclosure.

At step S1102, the first node receives a GTP-U PDU sent by the second node, and obtains the request information for the packet loss statistics included in the header of the GTP-U according to the GTP-U PDU.

Corresponding to the second node, when the first node receives the GTP-U PDU, the first node parses the GTP-U PDU to obtain the request information for the packet loss statistics included in the header of the GTP-U, and performs the reporting of the first information based on the request information for the packet loss statistics.

In conclusion, the first node obtains, according to the GTP-U PDU sent by the second node, the request information for the packet loss statistics included in the header of the GTP-U, and sends the first information related to the packet loss statistics to the second node according to the request information for the packet loss statistics. The second node obtains the packet to be discarded or the packet loss-related information included in the first information to assist a core network in performing traffic and/or cost statistics, so as to avoid an inconsistency with the traffic and/or cost statistics on a terminal side.

An embodiment of the disclosure also provides another packet loss handling method. FIG. 12 is a flowchart of a packet loss handling method provided by another embodiment of the disclosure. The packet loss handling method may be executed alone, in combination with any embodiment of the disclosure or any possible implementation in the embodiment, or in combination with any technical scheme in the related art.

As illustrated in FIG. 12, the packet loss handling method includes the following step.

At step S1201, first information is sent to a second node in response to determining to perform a packet loss-related operation.

When a first node determines to perform the packet loss-related operation, the first node performs the packet loss-related operation. In order to synchronize a statistical result with the second node, the first node sends the first information related to the packet loss to the second node.

In some embodiments, the packet loss-related operation is any one of: monitoring packet loss, reporting packet loss-related information, and returning a packet to be discarded (i.e., sending a returned data packet). The packet loss-related operation is not limited herein.

Corresponding to the packet loss handling methods provided in the above-mentioned embodiments of FIGS. 2-12, the disclosure also provides a packet loss handling apparatuses. Since the packet loss handling apparatus provided in the embodiments of the disclosure corresponds to the packet loss handling methods provided in the above-mentioned embodiments of FIGS. 2-12, the implementations of the packet loss handling methods are also applicable to the packet loss handling apparatus provided in the embodiments of the disclosure, and will not be described in detail in the embodiment of the disclosure.

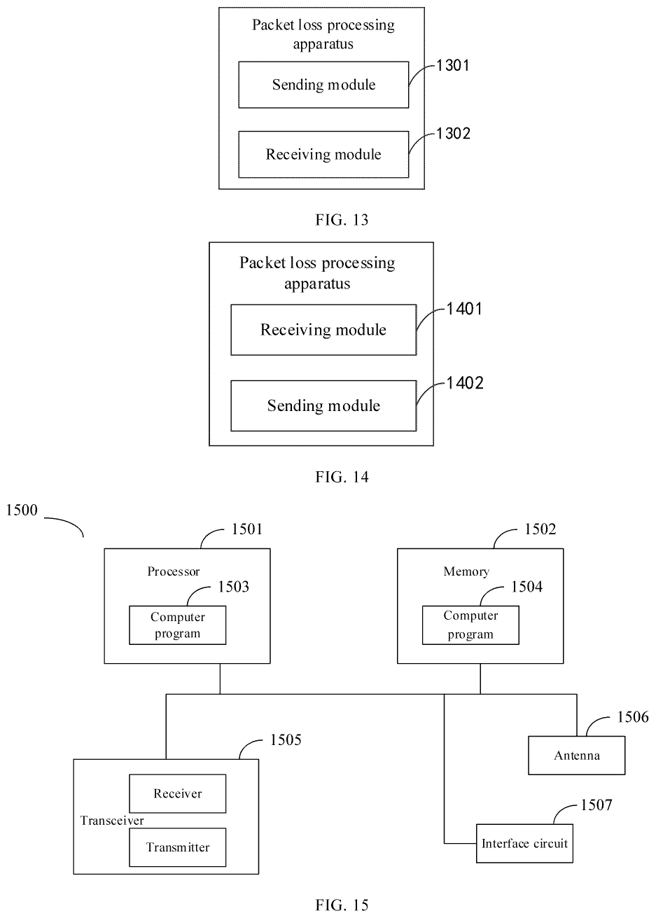

FIG. 13 is a schematic diagram of a packet loss handling apparatus provided by an embodiment of the disclosure. The apparatus is provided at a first node, and includes:
a sending module 1301, configured to send first information to a second node, in which the first information includes a packet to be discarded or packet loss-related information.

In a possible implementation of the embodiment of the disclosure, the packet to be discarded or the packet loss-related information is used to assist a core network in performing cost statistics.

In a possible implementation of the embodiment of the disclosure, the sending module 1301 is further configured to:
send the first information to the second node through a CP.

In a possible implementation of the embodiment of the disclosure, the first node, the second node and the first information are determined based on at least one of the following:
the first node being a gNB-DU, the second node bing a gNB-CU or a gNB-CU-CP, and the first information being an F1AP message;
the first node being a gNB-CU-UP, the second node being a gNB-CU-CP, and the first information being an EAP message;
the first node being a secondary node, the second node being a master node, and the first information being an XnAP message; or
the first node being a gNB, a gNB-CU, a gNB-CU-CP or a gNB-CU-UP, the second node being a core network node, and the first information being an NGAP message.

In a possible implementation of the embodiment of the disclosure, the sending module 1301 is further configured to:
send the first information to the second node through a UP.

In a possible implementation of the embodiment of the disclosure, the first node and the second node are determined based on to at least one of the following:
the first node being a gNB-DU, and the second node being a gNB-CU or a gNB-CU-UP;
the first node being a gNB, a gNB-CU or a gNB-CU-UP, and the second node being a UPF; or
the first node being a secondary node, and the second node being a master node.

In a possible implementation of the embodiment of the disclosure, the sending module 1301 is further configured to:
send the packet to be discarded to the second node through a GTP-U, in which a header of the GTP-U comprises packet loss indication information, and the packet loss indication information is used to indicate the second node to determine whether a GTP-U PDU is the packet to be discarded.

In a possible implementation of the embodiment of the disclosure, the sending module 1301 is further configured to:
send the packet loss-related information to the second node through a GTP-U, in which a header of the GTP-U includes the packet loss-related information.

In a possible implementation of the embodiment of the disclosure, the packet loss-related information includes at least one of:
a bearer ID corresponding to packet loss, a packet loss time, a packet loss data volume, a packet loss rate, a packet loss cause or a reporting cause.

In a possible implementation of the embodiment of the disclosure, the sending module 1301 is further configured to:
in response to receiving second information sent by the second node, send the first information to the second node, in which the second information includes request information for packet loss statistics.

In a possible implementation of the embodiment of the disclosure, the apparatus further includes:
a receiving module 1302, configured to receive second information sent by the second node through a UP.

In a possible implementation of the embodiment of the disclosure, the receiving module 1302 is further configured to:
receive a Gtp-u Pdu Sent by the Second Node; and
obtain the request information for the packet loss statistics included in a header of a GTP-U according to the GTP-U PDU.

In a possible implementation of the embodiment of the disclosure, the first node and the second node are determined based on at least one of the following:
the first node being a gNB-DU, and the second node being a gNB-CU or a gNB-CU-UP;
the first node being a gNB, a gNB-CU or a gNB-CU-UP, and the second node being a UPF; or
the first node being a secondary node, and the second node being a master node.

In a possible implementation of the embodiment of the disclosure, the receiving module 1302 is further configured to:
receive the second information sent by the second node through a CP.

In a possible implementation of the embodiment of the disclosure, the first node, the second node and the second information are determined based on at least one of the following:
the first node being a gNB-DU, the second node being a gNB-CU or a gNB-CU-CP, and the second information being an F1AP message;
the first node being a gNB-CU-UP, the second node being a gNB-CU-CP, and the second information being an E1AP message;
the first node being a master node, the second node being a secondary node, and the second information being an XnAP message;
the first node being a gNB, a gNB-CU, a gNB-CU-CP or a gNB-CU-UP, the second node being a core network node, and the second information being an NGAP message; or
the first node being a target gNB, the second node being a source gNB, and the second information being an XnAP message.

In a possible implementation of the embodiment of the disclosure, the request information for the packet loss statistics includes at least one of:
a packet loss statistical indication, a bearer ID of packet loss reporting, a threshold of packet loss reporting, a time of packet loss reporting and a mode of packet loss reporting.

In a possible implementation of the embodiment of the disclosure, the sending module 1301 is further configured to:
in response to determining to perform a packet loss-related operation, send the first information to the second node.

In a possible implementation of the embodiment of the disclosure, the packet loss-related operation is any one of:
monitoring packet loss, reporting the packet loss-related information, and returning the packet to be discarded.

FIG. 14 is a schematic diagram of a packet loss handling apparatus provided by an embodiment of the disclosure. The apparatus is provided at a second node, and includes:
a receiving module 1401, configured to receive first information sent by a first node, in which the first information includes a packet to be discarded or packet loss-related information.

In a possible implementation of the embodiment of the disclosure, the packet to be discarded or the packet loss-related information is used to assist a core network in performing cost statistics.

In a possible implementation of the embodiment of the disclosure, the receiving module 1401 is further configured to:
receive the first information sent by the first node through a CP.

In a possible implementation of the embodiment of the disclosure, the first node, the second node and the first information are determined based on at least one of the following:
the first node being a gNB-DU, the second node being a gNB-CU or a gNB-CU-CP, and the first information being an F1AP message;
the first node being a gNB-CU-UP, the second node being a gNB-CU-CP, and the first information being an E1AP message;
the first node being a secondary node, the second node being a master node, and the first information being an XnAP message; or
the first node being a gNB, a gNB-CU, a gNB-CU-CP or a gNB-CU-UP, the second node being a core network node, and the first information being an NGAP message.

In a possible implementation of the embodiment of the disclosure, the receiving module 1401 is further configured to:
receive the first information sent by the first node through a UP.

In a possible implementation of the embodiment of the disclosure, the first node and the second node are determined based on to at least one of the following:
the first node being a gNB-DU, and the second node being a gNB-CU or a gNB-CU-UP;
the first node being a gNB, a gNB-CU or a gNB-CU-UP, and the second node being a UPF; or
the first node being a secondary node, and the second node being a master node.

In a possible implementation of the embodiment of the disclosure, the receiving module 1401 is further configured to:
receive a GTP-U PDU sent by the first node; and
obtain packet loss indication information comprised in a header of a GTP-U according to the GTP-U PDU, wherein the packet loss indication information is used to indicate the second node to determine whether the GTP-U PDU is the packet to be discarded.

In a possible implementation of the embodiment of the disclosure, the receiving module 1401 is further configured to:
receive a GTP-U PDU sent by the first node; and
obtain the packet loss-related information comprised in a header of a GTP-U according to the GTP-U PDU.

In a possible implementation of the embodiment of the disclosure, the packet loss-related information includes at least one of:
a bearer ID corresponding to packet loss, a packet loss time, a packet loss data volume, a packet loss rate, a packet loss cause or a reporting cause.

In a possible implementation of the embodiment of the disclosure, the receiving module 1401 is further configured to:
receive the first information sent by the first node to the second node in response to the first node receiving second information sent by the second node, wherein the second information comprises request information for packet loss statistics.

In a possible implementation of the embodiment of the disclosure, the apparatus includes:
a sending module 1402, configured to send the second information to the first node.

In a possible implementation of the embodiment of the disclosure, the sending module 1402 is further configured to:
send the second information to the first node through a UP.

In a possible implementation of the embodiment of the disclosure, the sending module 1402 is further configured to:
send the second information to the first node through a GTP-U, in which a header of the GTP-U comprises the request information for the packet loss statistics.

In a possible implementation of the embodiment of the disclosure, the first node and the second node are determined based on at least one of the following:
the first node being a gNB-DU, and the second node being a gNB-CU or a gNB-CU-UP;
the first node being a gNB, a gNB-CU or a gNB-CU-UP, and the second node being a UPF; or
the first node being a secondary node, and the second node being a master nod.

In a possible implementation of the embodiment of the disclosure, the sending module 1402 is further configured to:
send the second information to the first node through a CP.

In a possible implementation of the embodiment of the disclosure, the first node, the second node and the second information are determined based on at least one of the following:
the first node being a gNB-DU, the second node being a gNB-CU or a gNB-CU-CP, and the second information being an F1AP message;
the first node being a gNB-CU-UP, the second node being a gNB-CU-CP, and the second information being an E1AP message;
the first node being a master node, the second node being a secondary node, and the second information being an XnAP message;
the first node being a gNB, a gNB-CU, a gNB-CU-CP or a gNB-CU-UP, the second node being a core network node, and the second information being an NGAP message; or
the first node being a target gNB, the second node being a source gNB, and the second information being an XnAP message.

In a possible implementation of the embodiment of the disclosure, the request information for the packet loss statistics comprises at least one of:
a packet loss statistical indication, a bearer identifier of packet loss reporting, a threshold of packet loss reporting, a time of packet loss reporting or a mode of packet loss reporting.

In a possible implementation of the embodiment of the disclosure, the receiving module 1401 is further configured to:
receive the first information sent, in response to the first node determining to perform a packet loss-related operation, by the first node to the second node.

In a possible implementation of the embodiment of the disclosure, the packet loss-related operation is any one of:
monitoring packet loss, reporting the packet loss-related information, and returning the packet to be discarded.

FIG. 15 is a schematic diagram of a communication apparatus 1500 provided by an embodiment of the disclosure. As illustrated in FIG. 15, the communication apparatus 1500 may be a network device, a terminal, or a chip, a chip system or a processor that supports the network device to realize the above-described methods, or a chip, a chip system or a processor that supports the terminal to realize the above-described methods. The apparatus may be configured to realize the methods described in the above method embodiments with reference to the descriptions of the above-described method embodiments.

The communication apparatus 1500 may include one or more processors 1501. The processor 1501 may be a general purpose processor or a dedicated processor, such as, a baseband processor or a central processor. The baseband processor is configured for processing communication protocols and communication data. The central processor is configured for controlling the communication apparatus (e.g., base station, baseband chip, terminal, terminal chip, CU or DU), executing computer programs, and processing data of the computer programs.

In some embodiments, the communication apparatus 1500 may further include one or more memories 1502 on which a computer program 1504 may be stored. When the processor 1501 executes the computer program 1504, the communication apparatus 1500 is caused to perform the methods described in the above method embodiments. In some embodiments, data may also be stored in the memory 1502. The communication apparatus 1500 and the memory 1502 may be provided separately or may be integrated together.

In some embodiments, the communication apparatus 1500 may also include a transceiver 1505 and an antenna 1506. The transceiver 1505 may be referred to as transceiver unit, transceiver machine, or transceiver circuit, for realizing the transceiver function. The transceiver 1505 may include a receiver and a transmitter. The receiver may be referred to as receiver machine or receiving circuit, for realizing the receiving function. The transmitter may be referred to as transmitter machine or transmitting circuit, for realizing the transmitting function.

In some embodiments, the communication apparatus 1500 may also include one or more interface circuits 1507. The interface circuits 1507 are configured to receive code instructions and transmit them to the processor 1501. The processor 1501 runs the code instructions to cause the communication apparatus 1500 to perform the methods described in the method embodiments.

When the communication apparatus 1500 is a first node, the transceiver 1505 is configured to perform steps such as step 201 in FIG. 2.

When the communication apparatus 1500 is a network device, the transceiver 1505 is configured to perform steps such as step 402 in FIG. 4.

In an implementation, the processor 1501 may include a transceiver for implementing the receiving and transmitting functions. The transceiver may be, for example, a transceiver circuit, an interface, or an interface circuit. The transceiver circuit, interface, or interface circuit for implementing the receiving and transmitting functions may be separated or may be integrated together. The transceiver circuit, interface, or interface circuit described above may be configured for code/data reading and writing, or may be configured for signal transmission or delivery.

In an implementation, the processor 1501 may store a computer program 1503 that may be executed by the processor 1501 and may cause the communication apparatus 1500 to perform the methods described in the method embodiments above. The computer program 1503 may be solidified in the processor 1501, in which case the processor 1501 may be implemented by hardware.

In an implementation, the communication apparatus 1500 may include circuits. The circuits may implement the sending, receiving or communicating function in the preceding method embodiments. The processor and the transceiver described in this disclosure may be implemented on integrated circuits (ICs), analog ICs, radio frequency integrated circuits (RFICs), mixed signal ICs, application specific integrated circuits (ASICs), printed circuit boards (PCBs), and electronic devices. The processor and the transceiver can also be produced using various IC process technologies, such as complementary metal oxide semiconductor (CMOS), nMetal-oxide-semiconductor (NMOS), positive channel metal oxide semiconductor (PMOS), bipolar junction transistor (BJT), bipolar CMOS (BiCMOS), silicon-germanium (SiGe), gallium arsenide (GaAs) and so on.

The communication apparatus in the descriptions of the above embodiments may be a network device or a terminal, but the scope of the communication apparatus described in the disclosure is not limited thereto, and the structure of the communication apparatus may not be limited by FIG. 15. The communication apparatus may be a stand-alone device or may be part of a larger device. For example, the described communication apparatus may be:
(1) a stand-alone IC, chip, chip system or subsystem;
(2) a collection of ICs including one or more ICs, in some examples, the collection of ICs may also include storage components for storing data and computer programs;
(3) an ASIC, such as a modem;
(4) modules that may be embedded within other devices;
(5) receivers, terminals, smart terminals, cellular phones, wireless devices, handheld machines, mobile units, in-vehicle devices, network devices, cloud devices, artificial intelligence devices, and the like; and
(6) others.

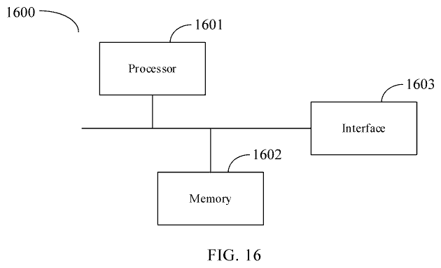

The case that the communication apparatus is a chip or a chip system may be referred to the schematic diagram of the chip shown in FIG. 16. The chip 1600 shown in FIG. 16 includes a processor 1601 and an interface 1603. There may be one or more processors 1601, and there may be multiple interfaces 1603.

For the case where the chip is configured to realize the function of the first node in the embodiment of the disclosure,
the interface 1603 is configured to execute step 201 in FIG. 2, Step 301 in FIG. 3, Step 401 in FIG. 4, and Step 501 in FIG. 5.

For the case where the chip is configured to realize the function of the second node in the embodiment of the disclosure,
the interface 1603 is configured to execute step 402 in FIG. 4 and step 502 in FIG. 5.

In some embodiments, the chip 1600 further includes a memory 1602 configured for storing necessary computer programs and data.

It is understandable by those skilled in the art that various illustrative logical blocks and steps listed in the embodiments of the disclosure may be implemented by electronic hardware, computer software, or a combination of both. Whether such function is implemented by hardware or software depends on the particular application and the design requirements of the entire system. Those skilled in the art may, for each particular application, use various methods to implement the described function, but such implementation should not be construed as being beyond the scope of protection of the embodiments of the disclosure.

The disclosure also provides a readable storage medium having instructions stored thereon. When the instructions are executed by a computer, the function of any of the method embodiments described above is implemented.

The disclosure also provides a computer program product. When the computer program product is executed by a computer, the function of any of the method embodiments described above is implemented.

The above embodiments may be implemented in whole or in part by software, hardware, firmware, or any combination thereof. When implemented using software, it may be implemented, in whole or in part, in the form of a computer program product. The computer program product includes one or more computer programs. When loading and executing the computer program on the computer, all or part of processes or functions described in the embodiments of the disclosure are implemented. The computer may be a general-purpose computer, a dedicated computer, a computer network, or other programmable devices. The computer program may be stored in a computer-readable storage medium or transmitted from one computer-readable storage medium to another computer-readable storage medium. For example, the computer program may be transmitted from one web site, computer, server, or data center to another web site, computer, server, or data center, in a wired manner (e.g., by using coaxial cables, fiber optics, or digital subscriber lines (DSLs) or wirelessly (e.g., by using infrared wave, wireless wave, or microwave). The computer-readable storage medium may be any usable medium to which the computer has access or a data storage device integrated by one or more usable mediums such as a server and a data center. The usable medium may be a magnetic medium (e.g., floppy disk, hard disk, and tape), an optical medium (e.g., a high-density digital video disc (DVD)), or a semiconductor medium (e.g., a solid state disk (SSD)).

Those skilled in the art understand that “first”, “second”, and other various numerical numbers involved in the disclosure are only described for the convenience of differentiation, and are not used to limit the scope of the embodiments of the disclosure, or indicate the order of precedence.

The term “at least one” in the disclosure may also be described as one or more, and the term “multiple” may be two, three, four, or more, which is not limited in the disclosure. In the embodiment of the disclosure, for a type of technical features, “first”, “second”, and “third”, and “A”, “B”, “C” and “D” are used to distinguish different technical features of the type, the technical features described using the “first”, “second”, and “third”, and “A”, “B”, “C” and “D” do not indicate any order of precedence or magnitude.

It is understood that the term “multiple” in the disclosure refers to two or more, which is the similar for other quantifiers. The term “and/or” describes a relation of associated objects, which indicates three relations, for example, “A and/or B” indicates that A exists alone, A and B both exist, or B exists alone. The character “/” generally indicates that the associated objects before and after the character “/” is in an “or” relation. The singular forms of “a” and “the” are also intended to include plural forms, unless the context clearly indicates other meanings.

It is further understood that the meanings of terms such as “in response to”, “if” and “when” involved in this disclosure depend on the context and the actual application scenario. For example, the terms “if” used here may be interpreted as “when”or “while”.

The correspondences shown in the tables in this disclosure may be configured or may be predefined. The values of information in the tables are merely examples and may be configured to other values, which are not limited by the disclosure. In configuring the correspondence between the information and the parameter, it is not necessarily required that all the correspondences illustrated in the tables must be configured. For example, the correspondences illustrated in certain rows in the tables in this disclosure may not be configured. For another example, the above tables may be adjusted appropriately, such as splitting, combining, and the like. The names of the parameters shown in the titles of the above tables may be other names that may be understood by the communication apparatus, and the values or representations of the parameters may be other values or representations that may be understood by the communication apparatus. Each of the above tables may also be implemented with other data structures, such as, arrays, queues, containers, stacks, linear tables, pointers, chained lists, trees, graphs, structures, classes, heaps, and Hash tables.

1. A packet loss handling method, comprising:
sending, by a first node, first information to a second node, wherein the first information comprises a packet to be discarded or packet loss-related information.

2. The method of claim 1, wherein the packet to be discarded or the packet loss-related information is used to assist a core network in performing cost statistics.

3. The method of claim 1, wherein sending the first information to the second node, comprises:
sending the first information to the second node through a control plane (CP).

4. The method of claim 3, wherein the first node, the second node and the first information are determined based on at least one of the following:
the first node being a base station-distributed unit (next-generation nodeB (gNB)-DU), the second node being a base station-centralized unit (gNB-CU) or a base station-centralized unit-control plane (gNB-CU-CP), and the first information being a F1 application protocol (F1AP) message;
the first node being a base station-centralized unit-user plane (gNB-CU-UP), the second node being the gNB-CU-CP, and the first information being an E1 application protocol (E1AP) message;
the first node being a secondary node, the second node being a master node, and the first information being an Xn application protocol (XnAP) message; or
the first node being a gNB in a new radio (NR) system, the gNB-CU, the gNB-CU-CP or the gNB-CU-UP, the second node being a core network node, and the first information being an NG application protocol (NGAP) message.

5. The method of claim 1, wherein sending the first information to the second node, comprises:
sending the first information to the second node through a UP;
wherein the first node and the second node are determined based on to at least one of the following:
the first node being a gNB-DU, and the second node being a gNB-CU or a gNB-CU-UP;
the first node being a gNB, the gNB-CU or the gNB-CU-UP, and the second node being a user plane function (UPF); or
the first node being a secondary node, and the second node being a master node.

6. (canceled)

7. The method of claim 5, wherein sending the first information to the second node through the UP, comprises:
sending the packet to be discarded to the second node through a general packet radio service (GPRS) tunneling protocol for the UP (GTP-U), wherein a header of the GTP-U comprises packet loss indication information, and the packet loss indication information is used to indicate the second node to determine whether a GTP-U protocol data unit (PDU) is the packet to be discarded; or sending the packet loss-related information to the second node through the GTP-U. wherein a header of the GTP-U comprises the packet loss-related information.

8. (canceled)

9. The method of claim 1, wherein the packet loss-related information comprises at least one of following information:
a bearer identifier corresponding to packet loss, a packet loss time, a packet loss data volume, a packet loss rate, a packet loss cause or a reporting cause.

10. The method of claim 1, wherein sending the first information to the second node, comprises:
in response to receiving second information sent by the second node, sending the first information to the second node, wherein the second information comprises request information for packet loss statistics.

11. The method of claim 10, wherein receiving the second information sent by the second node to the first node, comprises:
receiving the second information sent by the second node through a UP;
wherein receiving the second information sent by the second node through the UP, comprises:
receiving a GTP-U PDU sent by the second node; and
obtaining the request information for the packet loss statistics comprised in a header of a GTP-U according to the GTP-U PDU;
wherein the first node and the second node are determined based on at least one of the following:
the first node being a gNB-DU, and the second node being a gNB-CU or a gNB-CU-UP;
the first node being a gNB, the gNB-CU or the gNB-CU-UP, and the second node being a UPF; or
the first node being a secondary node, and the second node being a master node.

12-13. (canceled)

14. The method of claim 10, wherein receiving the second information sent by the second node, comprises:
receiving the second information sent by the second node through a CP;
wherein the first node, the second node and the second information are determined based on at least one of the following:
the first node being a gNB-DU, the second node being a gNB-CU or a gNB-CU-CP, and the second information being an F1AP message;
the first node being a gNB-CU-UP, the second node being the gNB-CU-CP, and the second information being an E1AP message;
the first node being a master node, the second node being a secondary node, and the second information being an XnAP message;
the first node being a gNB, the gNB-CU, the gNB-CU-CP or the gNB-CU-UP, the second node being a core network node, and the second information being an NGAP message; or
the first node being a target gNB, the second node being a source gNB, and the second information being the XnAP message.

15. (canceled)

16. The method of claim 11, wherein the request information for the packet loss statistics comprises at least one of following information:
a packet loss statistical indication, a bearer identifier of packet loss reporting, a threshold of packet loss reporting, a time of packet loss reporting or a mode of packet loss reporting.

17. The method of claim 9, wherein sending the first information to the second node, comprises:
in response to determining to perform a packet loss-related operation, sending the first information to the second node;
wherein the packet loss-related operation comprises one of:
monitoring packet loss, reporting the packet loss-related information, and returning the packet to be discarded.

18. (canceled)

19. A packet loss handling method, comprising:
receiving, by a second node, first information sent by a first node, wherein the first information comprises a packet to be discarded or packet loss-related information.

20. The method of claim 19, wherein the packet to be discarded or packet loss-related information is used to assist a core network in performing cost statistics.

21. The method of claim 19, wherein receiving the first information sent by the first node, comprises:
receiving the first information sent by the first node through a control plane (CP); or
receiving the first information sent by the first node through a user plane (UP);
wherein receiving the first information sent by the first node through the UP, comprises:
receiving a general packet radio service (GPRS) tunneling protocol for the UP (GTP-U) protocol data unit (PDU) sent by the first node; and
obtaining packet loss indication information comprised in a header of a GTP-U according to the GTP-U PDU, wherein the packet loss indication information is used to indicate the second node to determine whether the GTP-U PDU is the packet to be discarded;
or
wherein receiving the first information sent by the first node through the UP, comprises:
receiving a GTP-U PDU sent by the first node; and
obtaining the packet loss-related information comprised in a header of the GTP-U according to the GTP-U PDU.

22-27. (canceled)

28. The method of claim 19, wherein receiving the first information sent by the first node comprises:
receiving the first information sent by the first node to the second node in response to the first node receiving second information sent by the second node, wherein the second information comprises request information for packet loss statistics.

29. The method of claim 28, further comprising:
sending the second information to the first node;
wherein sending the second information to the first node, comprises:
sending the second information to the first node through a UP; or
sending the second information to the first node through a CP;
wherein sending the second information to the first node through the UP, comprises:
sending the second information to the first node through a GTP-U, wherein a header of the GTP-U comprises the request information for the packet loss statistics.

30-35. (canceled)

36. The method of claim 19, wherein receiving the first information sent by the first node, comprises:
receiving the first information sent, in response to the first node determining to perform a packet loss-related operation, by the first node to the second node.

37-39. (canceled)

40. A communication apparatus, comprising a processor and a memory, wherein the memory stores a computer program which, when executed by the processor, causes the apparatus to perform the method of claim 1.

41. (canceled)

42. A communication apparatus, comprising a processor and a memory, wherein the memory stores a computer program which, when executed by the processor, causes the apparatus to perform the method of claim 19.
